(19) United States
(12) Patent Application Publication
(10) Pub. No.: US 2009/0200714 A1
(43) Pub. Date: Aug. 13, 2009

(54) CUTTING APPARATUS

(76) Inventor: Jong-Tai Moon, Incheon (KR)

Correspondence Address: IPLA P.A., 3580 WILSHIRE BLVD., 17TH FLOOR, LOS ANGELES, CA, 90010, US

(21) Appl. No.: 12/302,872

(22) PCT Filed: May 29, 2007
(86) PCT No.: PCT/KR2007/002583

§ 371 Date: Nov. 28, 2008

(30) Foreign Application Priority Data
May 29, 2006 (KR) 10-2006-0047976
May 28, 2007 (KR) 10-2007-0051409

(51) Int. Cl. B23K 7/10

(52) U.S. Cl. 266/69

(57) ABSTRACT

A cutting apparatus is disclosed. The cutting apparatus includes, a rail, a body including a torch, a gas supplier, an arm carrying the torch, and wheels seated on the rail, to move in a direction intersecting an extension direction of the arm, an arm driver including an arm driving motor to move the arm in the extension direction of the arm, a wheel driver including a wheel driving motor to rotate the wheels, a fixing bar extending in an extension direction of the rail and having a bent upper end, and a body fixing unit including a fixing rod extending downwardly from the body, and a roller mounted to a lower end of the fixing rod such that the roller is positioned beneath the bent upper end of the fixing bar, the fixing rod being movable toward the body to cause the roller to be pressed against the rail.

### TECHNICAL FIELD

The present invention relates to a cutting apparatus, and more particularly to a cutting apparatus, in which a body is fixed to a rail provided with a fixing bar via a body fixing unit, so that the body is prevented from moving during a cutting process due to an external pressure, thereby enabling the cutting apparatus to perform a precise cutting process.

### BACKGROUND ART

A general cutting apparatus has a configuration in which a plate, on which a rail is seated, is cut by a torch moving along the rail above the rail, using flames of ignited high-pressure oxygen and LPG gas at the torch.

In this case, vibrations are generated in the cutting apparatus due to a propulsion force generated when flames are ignited at the torch, vibrations of a motor adapted to rotate wheels of the cutting apparatus, or a pressure externally applied to the cutting apparatus (hereinafter, referred to as an “external pressure”). As a result, the cutting apparatus is frequently separated from the rail.

For this reason, the conventional cutting apparatus has a problem in that it is unsuitable for a precise cutting process.

### DISCLOSURE

### Technical Problem

Therefore, the present invention has been made in view of the above problems, and it is an object of the present invention to provide a cutting apparatus, in which a body is fixed to a rail provided with a fixing bar via a body fixing unit, so that the body is prevented from moving during a cutting process due to an external pressure, thereby enabling the cutting apparatus to perform a precise cutting process.

### Technical Solution

In accordance with an aspect of the present invention, the above and other objects can be accomplished by the provision of a cutting apparatus comprising: a rail; a body including a torch provided with a flame nozzle for generating flames in accordance with an ignition of a gas, a gas supplier for controlling whether or not the gas should be supplied to the torch, an arm carrying the torch at one end of the arm, and wheels seated on the rail, the wheels being movable in a direction intersecting an extension direction of the arm; an arm driver including an arm driving motor to move the arm in the extension direction of the arm; a wheel driver including a wheel driving motor to rotate the wheels; a fixing bar protruded from the rail toward the body, the fixing bar extending in an extension direction of the rail and having a bent upper end; and a body fixing unit including a fixing rod extending downwardly from a bottom of the body and having a bent lower end, and a roller mounted to the lower end of the fixing rod such that the roller is positioned beneath the bent upper end of the fixing bar, the fixing rod being movable toward the body to cause the roller to be pressed against the rail.

The arm may include an arm stopper protruded from the arm in a direction intersecting the extension direction of the arm. The rail may include a body stopper protruded from the rail toward the body seated on the rail. The arm driver may further include a first sensor for sensing a contact state, in which the arm stopper comes into contact with the first sensor during a movement of the arm. The body may further include a second sensor for sensing a contact state, in which the body stopper comes into contact with the second sensor during a movement of the body along the rail, and a controller for stopping the arm driving motor when the first sensor senses the contact state of the arm stopper, and stopping the wheel driving motor when the second sensor senses the contact state of the body stopper.

The gas supplier may include a valve for controlling whether or not the gas should be supplied to the touch, and a valve cylinder for closing the valve. The controller may control the valve cylinder to close the valve when the controller stops the arm driving motor and the wheel driving motor in accordance with sensing operations of the first and second sensors.

The body fixing unit may further include a first cylinder for downwardly moving the fixing rod, thereby causing the fixing rod to release a pressing force of the roller applied to the fixing bar, and an elastic member for upwardly moving the fixing rod when a force from the first cylinder causing the fixing rod to move downwardly is released, thereby causing the fixing rod to press the roller against the fixing bar.

The wheel driver may further include a first clutch unit, which receives a rotating force from the wheel driving motor, to rotate, a second clutch unit for transmitting the rotating force from the wheel driving motor to the wheels, and a second cylinder for urging the second clutch unit to engage with first clutch unit, thereby causing the second clutch unit to rotate.

The body may further include a first switch for activating the body fixing unit, and a second switch for activating the wheel driver. The controller may control the first cylinder of the body fixing unit to downwardly move the fixing rod when the first switch operates, and controls the second cylinder of the wheel driver to release an urging force applied to the second clutch unit when the second switch operates.

The cutting apparatus may further comprise a solenoid valve for supplying the gas to the valve cylinder, the first cylinder, and the second cylinder. Each of the valve cylinder, the first cylinder, and the second cylinder may comprise a pneumatic cylinder. The gas supplier may further include a gas inlet tube for receiving the gas supplied to the gas supplier, a first gas outlet tube for discharging the gas received by the gas inlet tube to the torch, and a second gas outlet tube for discharging the gas received by the gas inlet tube to the solenoid valve. The valve cylinder may be arranged between the gas inlet tube and the first gas outlet tube. The controller may control the solenoid valve to control the supply of the gas to the valve cylinder, the first cylinder, and the second cylinder.

The arm may include a sample holder fixed to the arm at one end of the sample holder, the sample holder holding a sample at the other end of the sample holder, a motor, which moves along an outer periphery of the sample while rotating, the motor having a lower end, to which the torch is mounted, and a supporting unit including a first support carrying the motor at one end of the first support, a first hinge unit mounted to the other end of the first support, to pivot one end of the first support in accordance with the movement of the motor, a second support connected to the first hinge unit at one end of the second support, a third support fixedly mounted to the arm at one end of the third support, and a second hinge unit mounted to the other end of the third support, to hingeably move the first hinge unit about the other end of the third support in accordance with the movement of the motor.

The arm may include a motor, a motor holder fixedly mounted to the arm at one end of the motor holder, the motor holder holding the motor the other end of the motor holder, and a rotating member having one end rotating by the motor, and the other end bent in a direction intersecting a rotating axis of the motor, the rotating member holding the torch at the other end of the rotating member.

The extension direction of the arm may correspond to a protrusion direction of the fixing bar. The arm driver may include a first arm driver for moving the arm in the extension direction of the arm, the first arm driver including the arm driving motor, and a second arm driver for moving the first arm driver, to move the arm in a direction intersecting the extension direction of the arm.

The arm may include a groove extending in the extension direction of the arm. The first arm driver may further include a roller received in the groove. The roller rotates by the arm driving motor, to move the arm in the extension direction of the arm.

The second arm driver may includes a pinion gear, and a rack gear connected to the first arm driver at an upper surface of the rack gear, and engaged with the pinion gear at a lower surface of the rack gear, to move the first arm driver in a direction intersecting the extension direction of the arm in accordance with a rotation of the pinion gear.

The extension direction of the arm may correspond to a protrusion direction of the fixing bar. The rail may include a lower roller mounted to the rail and arranged beneath the rail, to move the rail in a direction intersecting the extension direction of the arm.

The torch may have a ball shape at an end of the torch opposite to the flame nozzle. The arm may include a ball joint, in which the ball-shaped end of the torch is fitted, and a torch pivoting unit including a rotating plate formed with a plurality of diametrically-arranged holes, a guide having one end connected to one of the holes of the rotating plate, and the other end connected to the torch, and a motor for rotating the rotating plate. Accordingly, the flame nozzle of the torch may pivot in one or more directions in accordance with a rotation of the motor.

### DESCRIPTION OF THE DRAWINGS

The above and other objects, features and other advantages of the present invention will be more clearly understood from the following detailed description taken in conjunction with the accompanying drawings, in which:

FIG. 1 is a perspective view of a cutting apparatus according to the present invention;

FIGS. 2 and 3 are views illustrating a body fixing unit in the cutting apparatus according to the present invention;

FIGS. 4 to 6 are views illustrating a wheel driving unit in the cutting apparatus according to the present invention;

FIGS. 7 to 9 are views illustrating a gas supplier in the cutting apparatus according to the present invention;

FIG. 10 is a block diagram illustrating a configuration in which a controller included in the cutting apparatus according to the present invention controls a solenoid valve;

FIG. 11 is a view illustrating an arm driver in the cutting apparatus according to the present invention;

FIG. 12 is a view illustrating a cutting apparatus for cutting a workpiece into a shape conforming to a sample in accordance with the present invention;

FIG. 13 is a view illustrating a cutting apparatus for cutting a workpiece into a ring shape in accordance with the present invention;

FIGS. 14 to 16 are view illustrating a cutting apparatus for cutting an H-beam in accordance with the present invention;

FIG. 17 is a view illustrating a flame nozzle holder in the cutting apparatus according to the present invention; and

FIG. 18 is a view illustrating a torch pivoting unit in the cutting apparatus according to the present invention.

### BEST MODE

Hereinafter, a cutting apparatus according to the present invention will be described in detail with reference to the accompanying drawings.

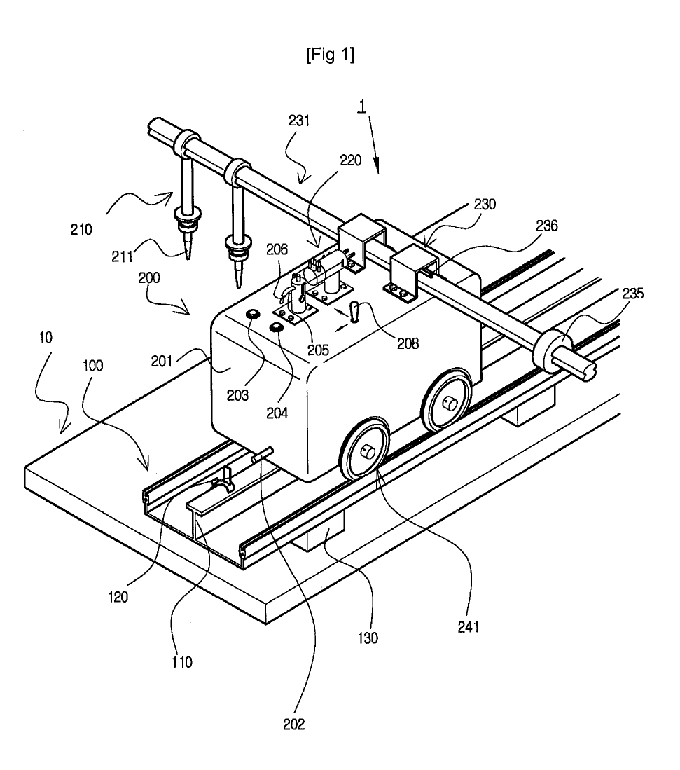

As shown in FIGS. 1, 2, and 4, the cutting apparatus 1 according to the present invention includes a rail 100, a body 200, an arm driver 230, a wheel driver 240, a fixing bar 110, and a body fixing unit 250.

The rail 100, on which the body 200 is seated, provides a movement path of the body 200. As shown in FIG. 1, the rail 100 is seated on a plate-shaped workpiece 10 to be cut. Where the workpiece 10 is made of a metal material, an electromagnet 130 is attached to a lower surface of the rail 100, in order to more firmly seat the rail 100 on an upper surface of the workpiece 10. Here, the electromagnet 130 means a magnet generating a magnetic force upon receiving electric power.

As shown in FIG. 1, the body 200 includes a case 201, torches 210, a gas supplier 220, an arm 231, and wheels 241.

Each torch 210 includes flame nozzles 211 for generating flames in accordance with ignition of gas supplied to the flame nozzles 211. The gas, which is ignited to generate flames, is a mixture of LPG gas and oxygen.

As shown in FIG. 1, the gas supplier 220 is provided to control whether or not gas should be supplied to the torches 210. Here, the gas means oxygen and LPG gas.

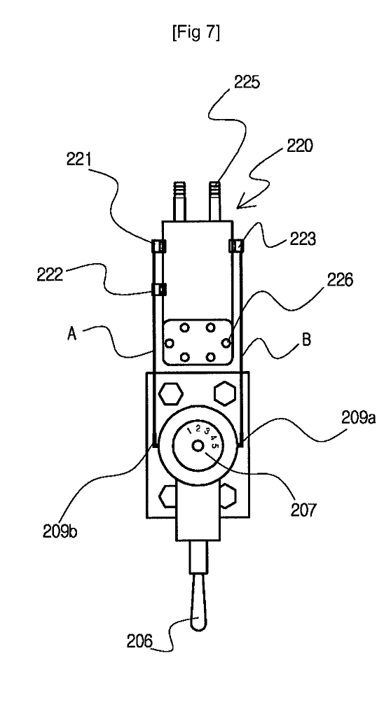

As shown in FIGS. 7 to 10, the gas supplier 220 includes gas inlet tubes 225, valves 221, 222, and 223, first gas outlet tubes 226, and a second gas outlet tube 227.

Oxygen and LPG gas from an oxygen storage tank (not shown) and an LPG storage tank (not shown) are introduced into the gas inlet tubes 225, respectively. The first gas outlet tubes 226 discharge the oxygen and LPG gas introduced through the gas inlet tubes 225 to the torches 210. Substantially, the first gas outlet tubes 226 and torches 210 are connected by a hose. Accordingly, the oxygen and LPG gas flow through the hose. However, the hose, which defines the flow path of the oxygen and LPG gas, is omitted from the drawings, for the simplicity and clearness of illustration.

The second gas outlet tube 227 is provided to supply the oxygen and LPG gas introduced through the gas inlet tubes 225 to a solenoid valve 270, which will be described later.

As shown in FIGS. 7 to 10, the valves 221, 222, and 223 of the gas supplier 220 controls the supply of oxygen and LPG gas. Here, the valves 221, 222, and 223 are provided as a low-pressure valve 221, a high-pressure valve 222, and a gas valve 223, respectively. The low-pressure valve 221 is a valve for allowing the torches 210 to spout low-pressure oxygen for ignition of flames. The high-pressure valve 222 is a valve for allowing the torches 210 to spout high-pressure oxygen after the ignition of flames by the low-pressure valve 221. The gas valve 223 is a valve for allowing the torches 210 to spout LPG gas after the ignition of flames by the low-pressure valve 221.

The torches 210 are arranged at one side of the arm 231. When the arm 231 is moved in an extension direction thereof by the arm driver 230, the torches 210 also move along with the arm 231. FIG. 1 illustrates an example in which two torches 210 are installed on the arm 231. However, the present invention is not limited to the number of torches 210 installed on the arm 231.

The extension direction of the arm 231 means a direction intersecting an extension direction of the rail 100, namely, a direction intersecting the movement path of the body 200.

The wheels 241 are mounted to the body 200 such that they move along the rail 100 in accordance with an operation of the wheel driver 240 including a wheel driving motor 242.

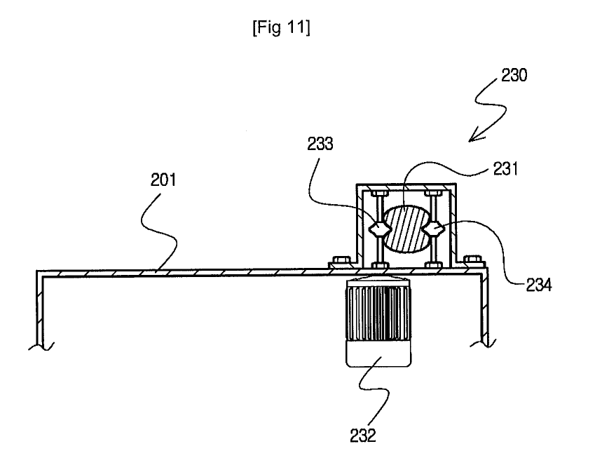

The arm driver 230 includes an arm driving motor 232 for moving the arm 231 in an extension direction of the arm 231. As shown in FIG. 11, the surface of the arm 231 is recessed to have a groove extending in an extension direction of the arm 231, in accordance with the present invention. A roller 233, which is rotated by the arm driving motor 232, is partially received in the groove of the arm 231 such that it moves along the groove while rotating. Accordingly, the arm 231 moves in the extension direction thereof in accordance with the rotation of the roller 233. The arm driver 230 may further include an auxiliary roller 234 for supporting the arm 231 at the side opposite to the roller 233. The auxiliary roller 234 supports the arm 231 when the arm 231 is moved by the arm driver 230.

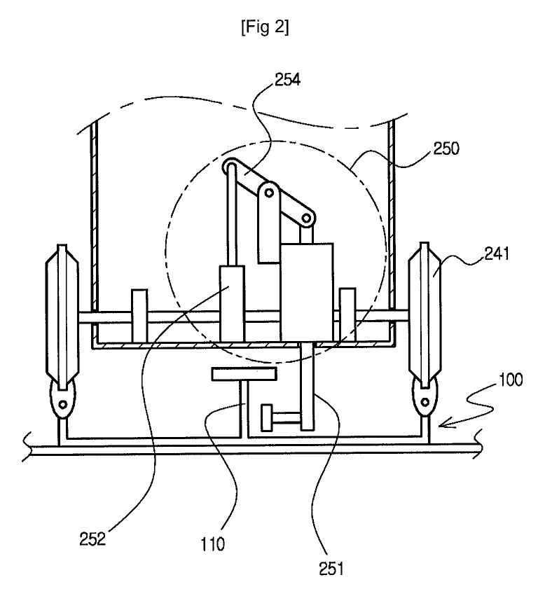

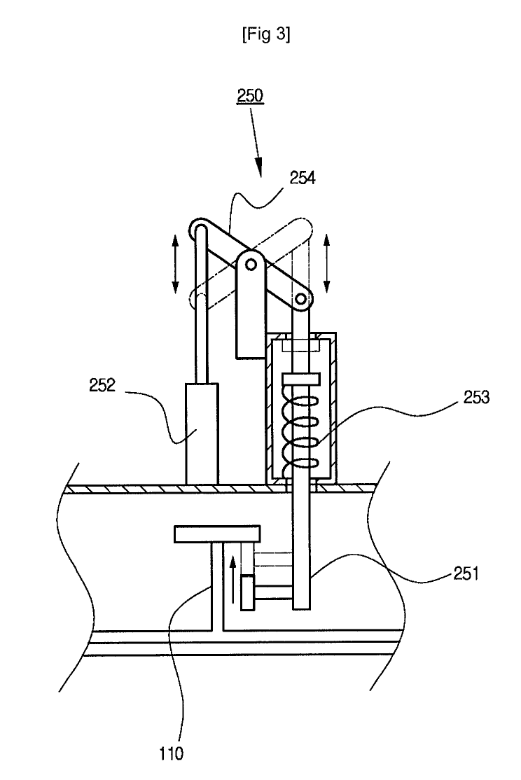

The fixing bar 110 is protruded from the rail 100 toward the body 200 seated on the rail 100. The fixing bar 110 has a bent upper end. The fixing bar 110 extends in a longitudinal direction of the rail 100. As shown in FIGS. 2 and 3, in accordance with the present invention, the fixing bar 110 has a cross-section having a T-shape. Of course, the fixing bar 110 may have a 180°-rotated L-shaped cross-section.

The body fixing unit 250 includes a fixing rod 251. The fixing rod 251 is downwardly protruded from the bottom of the body 200. The downwardly-protruded lower end of the fixing rod 251 is positioned beneath the bent upper end of the fixing bar 110. A roller 251a, which may comprise a bearing or the like, is mounted to the downwardly-protruded lower end of the fixing rod 251.

Upon a cutting process, the fixing rod 251 of the body fixing unit 250 moves upwardly such that the roller 251a mounted to the fixing rod 251 is pressed against the fixing bar 110. Accordingly, it is possible to prevent the body 200 from being separated from the rail 100 due to an external pressure.

As shown in FIG. 3, the body fixing unit 250 may include a first cylinder 252, a lever 254, and an elastic member 253.

The first cylinder 252 may comprise a pneumatic cylinder. The first cylinder 252 is supplied with a gas in accordance with an operation of the solenoid valve 270 controlled by a controller 260, which will be described later. In accordance with the supply of the gas, one end of the lever 254 is upwardly moved.

The lever 254 is always upwardly urged by the first cylinder 252 at one end of the lever 254, and is always upwardly urged by the elastic member 253 at the other end of the lever 254.

The elastic member 253 functions to upwardly move the fixing rod 251 such that the roller 233 of the fixing rod 251 is pressed against the bent upper end of the fixing bar 110.

When a gas is supplied to the first cylinder 252, the lever 254 downwardly moves the fixing rod 251. As a result, the pressing force of the roller 233 of the fixing rod 251 applied to the bent upper end of the fixing bar 110 is released. On the other hand, when the supply of the gas is stopped, the fixing rod 251 is upwardly moved by the elasticity of the elastic member 253, thereby causing the roller 233 of the fixing rod 251 to be pressed against the bent upper end of the fixing bar 110.

After the completion of the cutting process, the pressing force of the roller 233 of the fixing rod 251 applied to the bent upper end of the fixing bar 110 is released in accordance with an operation of the first cylinder 252. Thus, the body can be easily separated from the rail 100.

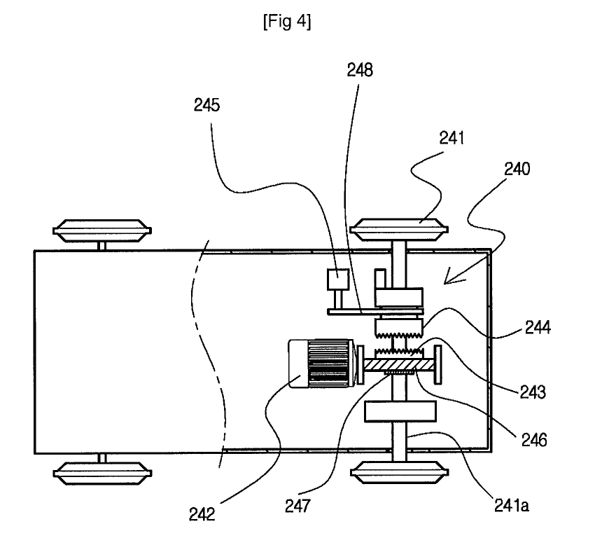

As shown in FIG. 4, the wheel driver 240 may further include a first clutch unit 243, a second clutch unit 244, and a second cylinder 245.

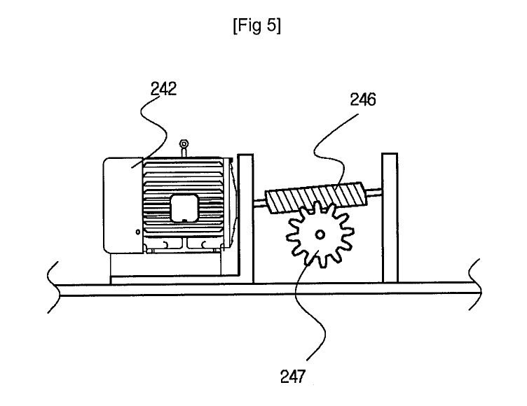

A rotation force generated from the wheel driving motor 242 is transmitted to the first clutch unit 243 via a worm 246 and a worm gear 247, as shown in FIG. 5. The first clutch unit 243 rotates independently of a wheel shaft 241a connecting the wheels 241, whereas the second clutch unit 244 can rotate along with the wheel shaft 241a because the second clutch unit 244 and wheel shaft 241a are coupled by a key (not shown). Accordingly, when the second clutch unit 244 rotates, the wheel shaft 241a rotates, thereby rotating the wheels 241.

The second cylinder 245 comprises a pneumatic cylinder. When the second cylinder 245 is supplied with a gas in accordance with an operation of the solenoid valve 270, which will be described later, the second clutch unit 244 is engaged with the first clutch unit 243.

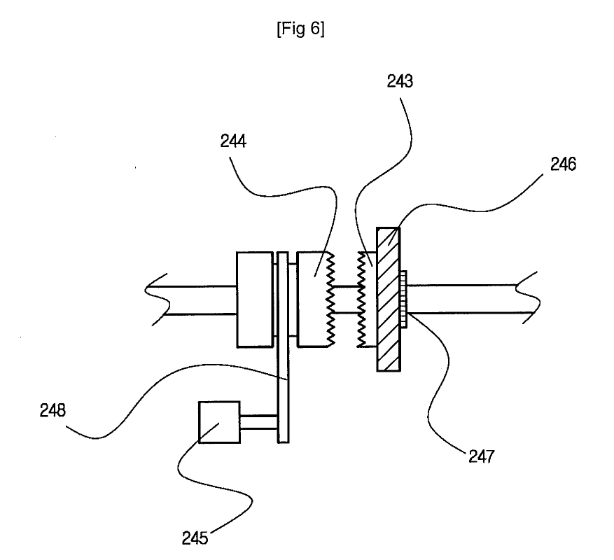

As shown in FIG. 6, the second clutch unit 244 is provided with grooves. A guide unit 248 is engaged with the grooves of the second clutch unit 244 as it is urged toward the second clutch unit 244. Accordingly, the second clutch unit 244 receives an urging force from the second cylinder 245 via the guide unit 248.

In a cutting process, accordingly, the second clutch unit 244 is engaged with the first clutch unit 243 by the second cylinder 245. As a result, the wheels 241 are rotated by the wheel driving motor 242. When the cutting process is completed, the second clutch unit 244 is disengaged from the first clutch unit 243. When the engagement between the second clutch unit 244 and the first clutch unit 243 are released, the user can manually separate the body 200 from the rail 100. Thus, when the cutting process is completed, the body 200 can be stored after being separated from the rail 100.

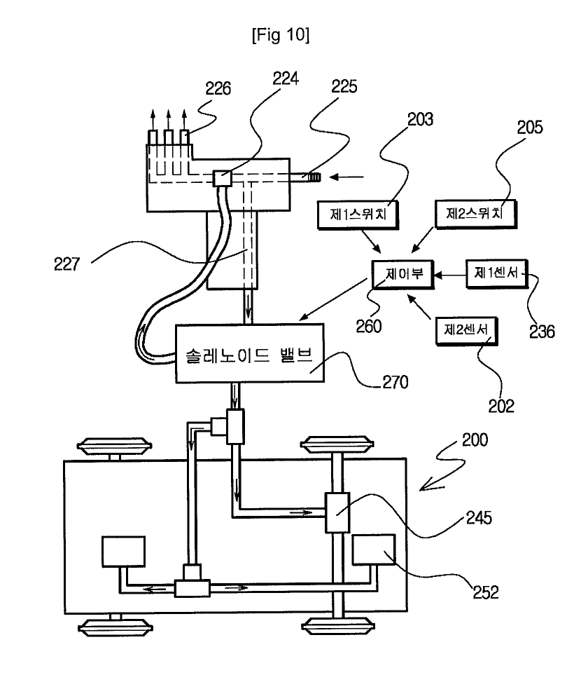

As shown in FIGS. 1 and 10, the cutting apparatus 1 according to the present invention further includes an arm stopper 235, a body stopper 120, a first sensor 236, and a second sensor 202. The controller 260 is also included in the cutting apparatus 1.

As shown in FIG. 1, the arm stopper 235 is mounted to the arm 231 such that it is protruded in a direction intersecting the extension direction of the arm 231.

The body stopper 120 is protruded from the rail 100 toward the body 200 seated on the rail 100. FIG. 1 illustrates an example in which the body stopper 120 is mounted to the fixing bar 110, in accordance with the present invention.

The first sensor 236 comprises a limit switch protruded from the arm driver 230 toward the arm stopper 235.

The second sensor 202 comprises a limit switch protruded from the body 200 toward the body stopper 120.

The controller 260 performs a control operation to stop the arm driving motor 232 when the arm stopper 235 mounted to the arm 231 comes into contact with the first sensor 235 during a movement of the arm 231. The controller 260 also performs a control operation to stop the wheel driving motor 242 when the body stopper 120 comes into contact with the second sensor 202 during a movement of the body 200 along the rail 100.

The arm stopper 235 can shift in the extension direction of the arm 231, so as to vary the mounting position thereof on the arm 231. The body stopper 120 has a clip structure, so as to vary the mounting position thereof on the fixing bar 110.

Accordingly, it is possible to adjust the cutting size of the workpiece 10 to be cut by the torch 210 by controlling the movement lengths of the arm 231 and body 200.

The gas supplier 200 may further include a valve cylinder 224. The valve cylinder 224 may comprise a pneumatic cylinder which is configured to close the valves 221, 222, and 223 upon receiving a gas via the solenoid valve 270, which will be described later. In this case, the controller 260 may perform a control operation to control the solenoid valve 270 to close the valves 221, 222, and 223 via the valve cylinder 224 while stopping the arm driving motor 232 and wheel driving motor 242, in accordance with the sensing results of the first and second sensors 236 and 202.

As shown in FIG. 10, the solenoid valve 270 is always supplied with a gas via the second gas outlet tube 227 of the gas supplier 220, and supplies the gas to the valve cylinder 224, first cylinder 252, and second cylinder 245. The solenoid valve 270 is controlled by the controller 260, to control whether or not the gas should be supplied to the valve cylinder 224, first cylinder 252, and second cylinder 245.

Since the solenoid valve 270 is supplied with the gas via the second gas outlet tube 227, as shown in FIG. 10, the supply of the gas to the solenoid valve 270 is continued even when the valves 221, 222, and 223 are closed by the valve cylinder 224.

The body 200 may further include a first switch 203 and a second switch 205, as shown in FIG. 1.

The first and second switches 203 and 205 are provided to separate the body 200 from the rail 100 when the cutting process is completed.

When the first switch 203 operates, the controller 260 controls the solenoid valve 270 to cause the first cylinder 252 of the body fixing unit 250 to urge the lever 254 such that the fixing rod 251 is downwardly moved. On the other hand, when the second switch 205 operates, the controller 260 performs a control operation to cause the second cylinder 245 of the wheel driver 240 to release a pressing force applied to the second clutch unit 244.

The body 200 may further include an ignition switch 204, a process start switch 208, a movement setting switch 206, a speed setting panel 207, a high-pressure piece 209b, and a low-pressure piece 209a.

The ignition switch 204 shown in FIG. 1 is a switch for activating a spark unit (not shown) installed adjacent to the flame nozzle of each torch 210, thereby igniting flames when low-pressure oxygen is spouted from the flame nozzle in accordance with opening of the low-pressure valve 221.

The process start switch 208 shown in FIG. 1 enables the controller 260 to control whether or not the arm driving motor 232 should operate. That is, when the process start switch 208 operates upon a transverse cutting process, the controller 260 performs a control operation to operate only the wheel driving motor 242. In this case, accordingly, the workpiece is cut only in a transverse direction.

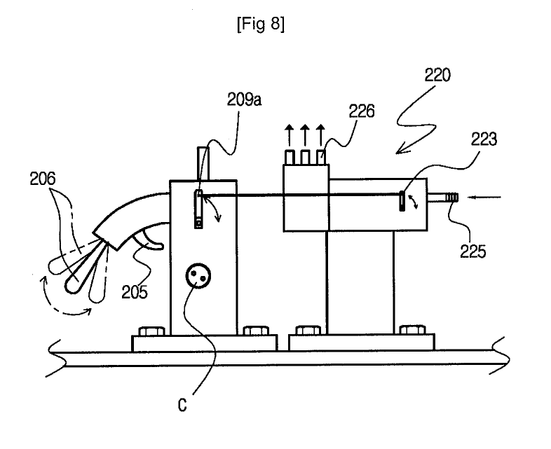

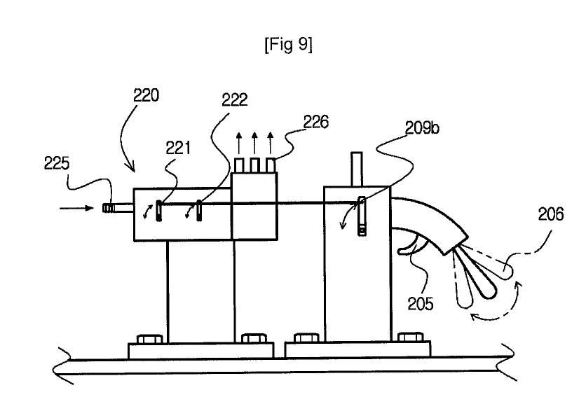

The movement setting switch 206 shown in FIG. 1 is a switch for setting the movement direction of the body 200 along the rail 100 (forward/backward movement direction). In response to an input from the movement setting switch 206, the controller 260 controls the wheel driving motor 242 to rotate the wheels 241 in a normal or reverse direction, and thus to set the movement direction of the body 200. For example, when the movement setting switch 206 pivots upwardly, as shown in FIGS. 8 and 9, the controller 260 rotates the wheel driving motor 242 in the normal direction. On the other hand, when the movement setting switch 206 pivots downwardly, the controller 260 rotates the wheel driving motor 242 in the reverse direction.

The speed setting panel 207 shown in FIG. 7 is provided to set the rotating speed of the wheel driving motor 242 via the controller 260, and thus to set the movement speed of the body 200.

As shown in FIGS. 7 to 9, the low-pressure valve 221 and high-pressure valve 222 are connected to the high-pressure piece 209 via a wire A. the gas valve 223 is connected to the low-pressure piece 209a via a wire B. Accordingly, when the low-pressure piece 209a and high-pressure piece 209b rotate, the gas valve 223, low-pressure valve 221, and high-pressure valve 222 can be simultaneously opened.

A socket C is provided to be connected with outlets (not shown) of motors 310 and 400, which will be described later, and thus to supply electric power to the motors 310 and 400.

Hereinafter, a procedure for cutting the workpiece 10 using the cutting apparatus 1 having the above-described configuration according to the present invention will be described.

First, the rail 100 is seated on the workpiece 10. Thereafter, electric power is supplied to the electromagnet 130 of the rail 100, to fix the rail 100 to the workpiece 10. The body 200 is then installed on the rail 100.

Thereafter, the positions of the body stopper 120 and arm stopper 235 are set.

Also, the movement direction and movement speed of the body 200 are set through the movement setting switch 206 and speed setting panel 207.

The high-pressure piece 209b is then rotated to open the low-pressure valve 221 and high-pressure valve 222. When the ignition switch 204 operates subsequently, flames are ignited at the torches 210.

After the ignition of flames at the torches 210, the lower-pressure piece 209a is rotated to open the gas valve 223. Accordingly, LPG gas is supplied to the flame-ignited torches 210.

Thereafter, the process start switch 208 operates, in order to cause the cutting apparatus to execute a transverse cutting process or a longitudinal/transverse cutting process.

When a command for the execution of the transverse cutting process is generated through the process start switch 208, the controller 260 operates the second cylinder 245 via the solenoid valve 270. As a result, the first and second clutch units 243 and 244 are engaged with each other. The controller 260 also operates the wheel drive motor 242, thereby causing the body 200 to move. As the body 200 moves, the torches 210 mounted to the arm 231 of the body 200 moves. Accordingly, the workpiece 10 is cut in a transverse direction.

On the other hand, when a command for the execution of the longitudinal/transverse cutting process is generated through the process start switch 208, the controller 260 first performs a control operation to move the body 200 along the rail 100 such that the transverse cutting process is executed. When the body stopper 120 is sensed by the second sensor 202, the controller 260 stops the wheel driving motor 242. Thereafter, the controller 260 operates the arm driving motor 232, to move the arm 231 until the arm stopper 235 is sensed by the first sensor 236. During the movement of the arm 231, the torches 210 mounted to the arm 231 cut the workpiece 10 while moving in a longitudinal direction.

After the completion of the cutting process, the controller 260 controls the solenoid valve 270 to close the valves 221, 222, and 223 via the valve cylinder 224. Accordingly, the supply of oxygen and LPG gas to the torches 210 is cut off.

When the operator operates the first and second switches 203 and 205, the controller 260 controls the solenoid valve 270 to release the force applied from the first cylinder 252 to the lever 254. The controller 260 also releases the operation of the second cylinder 245 via the solenoid valve 270, thereby causing the first and second clutch units 243 and 244 to be disengaged from each other. Thereafter, the operator collects the cut workpiece 10, and separates the body 200 from the rail 100, in order to store the body 200.

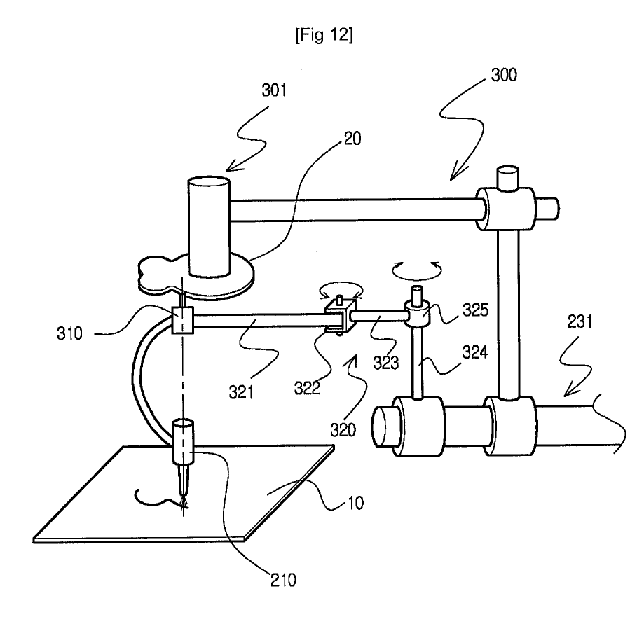

Hereinafter, another embodiment of the cutting apparatus 1 according to the present invention, in which a sample 20 as a model is used to cut the workpiece 10 such that the cut workpiece 10 has the same shape as the sample 20, will be described.

Where it is desired to cut the workpiece 10 to have the same shape as the sample 20, the arm 231 includes a motor 310, a sample holder 300, and a supporting unit 320, as shown in FIG. 12.

The sample holder 300 has a 180°-rotated L-shaped structure. The sample holder 300 is fixed, at one end thereof, to the arm 231. The sample 20 is firmly held by the other end of the sample holder 300. This embodiment is associated with an example in which the sample 200 is made of a metal material. In the illustrated example, accordingly, an electromagnet 301 is attached to the other end of the sample holder 300.

The motor 310 moves along the outer periphery of the sample 20 while rotating. A torch 210 is mounted to the motor 310, and arranged beneath the motor 310 such that the torch 210 moves along with the motor 310.

The supporting unit 320 includes a first support 321, a second support 323, a third support 324, a first hinge unit 322, a second hinge unit 325.

The motor 310 is mounted to one end of the first support 321.

The first hinge unit 322 is mounted to the other end of the first support 321, to cause one end of the first support 321 to pivot in accordance with the movement of the motor 310.

The first hinge unit 322 is also mounted to one end of the second support 323. The second hinge unit 325 is mounted to the other end of the second support 323.

The third support 324 is fixedly mounted, at one end thereof, to the arm 231. The second hinge unit 325 is also mounted to the other end of the third support 324.

Thus, the second hinge unit 325 hingeably connects the other end of the second support 323 and the other end of the third support 324. Accordingly, the first high unit 322 mounted to one end of the second support 323 pivots about the other end of the third support 324 by the second hinge unit 325.

In accordance with the hinge configuration of the supporting unit 320, the motor 310 can smoothly move along the outer periphery of the sample 20, which may have various shapes.

Since the torch 210 moves in accordance with the movement of the motor 310, it is possible to cut the workpiece 10 to have a shape conforming to the outer periphery of the sample 20.

Hereinafter, another embodiment of the cutting apparatus 1 according to the present invention, in which the workpiece 10 is cut into a ring shape, will be described.

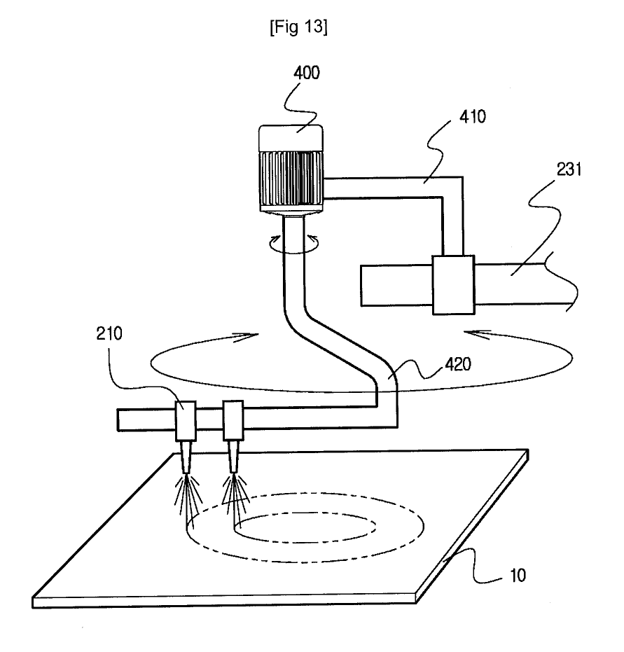

As shown in FIG. 13, the arm 231 may include a motor 400, a motor holder 410, and a rotating member 420.

The motor holder 410 is fixedly mounted, at one end thereof, to the arm 231. The motor 400 is held by the other end of the motor holder 410.

The rotating member 420 is rotated by the motor 400. The rotating member 420 has a substantially L-shape. Two torches 210 are mounted to the rotating member 420.

Accordingly, it is possible to cut the workpiece 10 into a ring shape during a rotation of the motor 310.

Thus, it is possible to eliminate the trouble involved in a conventional case in which a cutting process is executed two times using a single torch while rotating the torch at different radiuses, respectively, to cut the workpiece 10 into a ring shape.

Hereinafter, a cutting apparatus 1a, in which a torch 210 is appropriately positioned to cut an H-beam, as another embodiment of the cutting apparatus 1 according to the present invention, will be described.

In order to cut an H-beam 30, a cutting line is marked on the H-beam 30.

An electromagnet 130, which has a 180°-rotated L-shape, is mounted to the rail 100, in order to enable the rail 100 to be firmly seated on the H-beam 30.

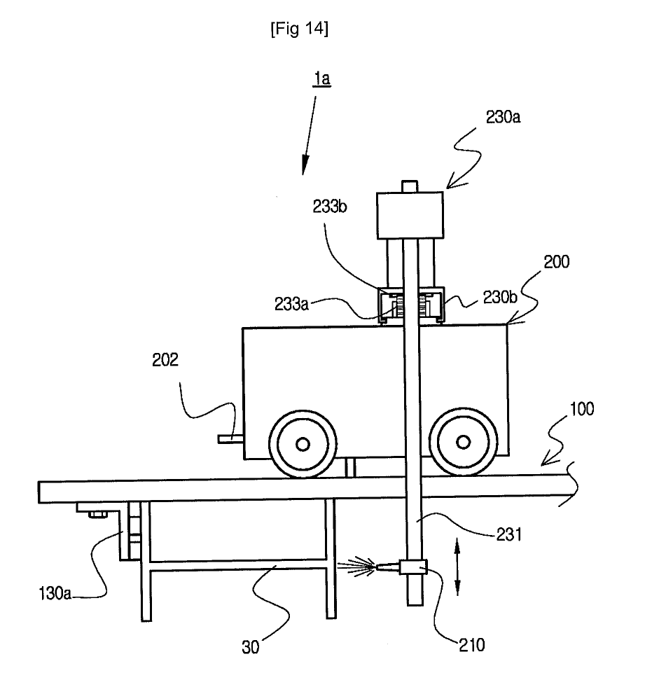

In the cutting apparatus 1a for cutting the H-beam 30, as shown in FIG. 14, the arm 231 thereof extends in a direction corresponding to the protrusion direction of the fixing bar 110. This direction corresponds to the vertical direction of the body 200 when viewing the drawing.

The arm driver 230 includes a first arm driver 230a including an arm driving motor 232, and a second arm driver 230b. The configuration of the first arm driver 230a is identical to the configuration of the arm driver 230 adapted to cut the plate-shaped workpiece 10, so that no description thereof will be given.

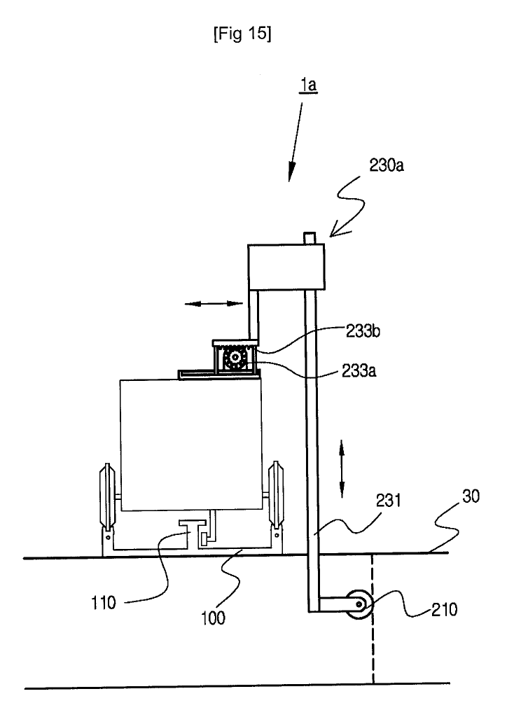

As shown in FIGS. 14 and 15, the second arm driver 230b includes a pinion gear 233a and a rack gear 233b.

The pinion gear 233a is engaged with the rack gear 233b at a lower portion of the rack gear 233b, to convert a rotation of the pinion gear 233a to a reciprocal movement of the rack gear 233b. In accordance with the rotation of the pinion gear 233a, the rack gear 233b moves the first arm driver 230a in a direction intersecting the extension direction of the arm 231.

Accordingly, as shown in FIG. 15, when the pinion gear 233a rotates, the second arm driver 230b moves in a lateral direction when viewing the drawing. Accordingly, the operator can align the torch 210 mounted on the arm 231 with the cutting line marked on the H-beam 30. When the first arm driver 230a operates in this state, it is possible to accurately cut the H-beam 30.

In this case, of course, a handle (not shown) or a motor (not shown) may be provided to rotate the pinion gear 233a.

Hereinafter, a cutting apparatus 1b, in which a lower roller 140 is mounted to the rail 100, as another embodiment of the cutting apparatus 1 according to the present invention, will be described.

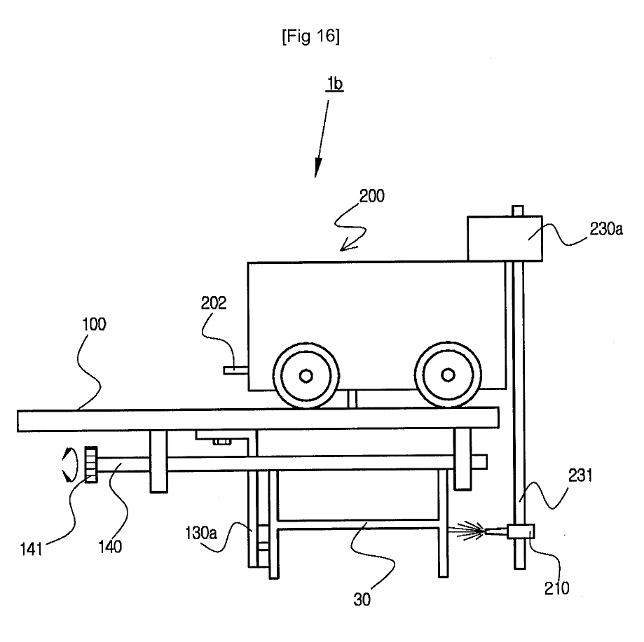

As shown in FIG. 16, the lower roller 140 has a pipe shape, and is mounted beneath the rail 100. A handle 141 is provided at one end of the lower roller 140.

In this case, the operator rotates the lower roller 140 using the handle 141 after seating the rail 100 carrying the body 200, on the H-beam 30. Accordingly, it is possible to align the torch 210 with the cutting line.

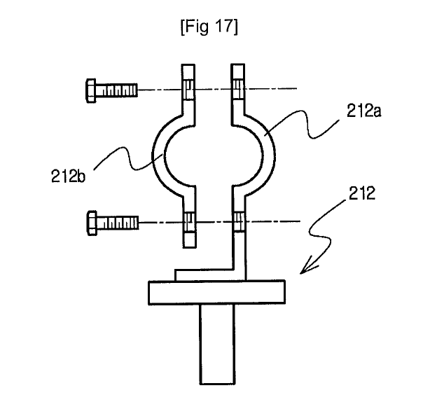

Meanwhile, the torch 210, which is mounted to the cutting apparatus according to the present invention, may include a first flame nozzle holder 212a and a second flame nozzle holder 212b, as shown in FIG. 17. The flame nozzle holders 212a and 212b are adapted to couple the flame nozzle to the torch 210. As shown in FIG. 17, the first and second flame nozzle holders 212a and 212b have, at central portions thereof, grooves facing each other, respectively, to hold the flame nozzle. The first and second flame nozzle holders 212a and 212b are coupled through fastening of screws. In accordance with this structure, it is possible to selectively couple flame nozzles having different sizes to the torch 210.

Typically, where it is desired to weld thick plates through a welding process, the welding process is carried out after cutting the corners of the plates. In this case, when the corner-cut plates are joined such that the corners of the plates face each other, a V-shaped cross-section is formed at a region where the corners of the plates are positioned.

Thereafter, the welding process is carried out by applying flames spouted from the torch 210 while bringing a welding rod (not shown) into contact with the V-shaped region where the corners of the plates are positioned. At this time, it may be necessary to fill up the V-shaped region while swinging the torch 210, as in general cases.

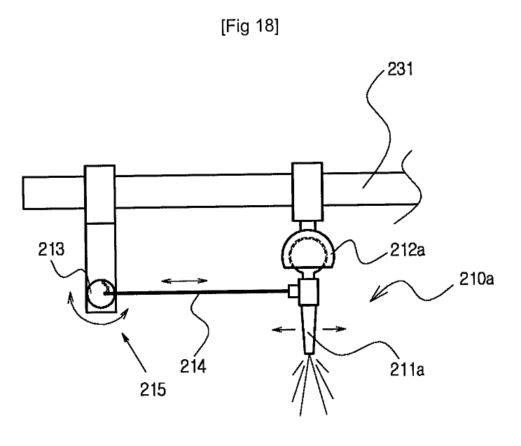

To this end, as shown in FIG. 18, the cutting apparatus 1 according to the present invention may include a configuration capable of performing a welding process such that the V-shaped region, where the corners of the plates are positioned, is filled up. As this configuration, the cutting apparatus 1 may further include a torch pivoting unit 215.

In this case, the arm 231 includes a ball joint 212a mounted to the arm 231.

Also, the cutting apparatus 1 includes a torch 210a having a ball shape at an end opposite to a flame nozzle 211a. The ball-shaped end of the torch 210a is fitted in the ball joint 212a.

The torch pivoting unit 215 includes a rotating plate 213, a guide 214, and a motor (not shown).

The rotating plate 213 is rotated in accordance with a rotation of the motor. A plurality of diametrically-arranged holes are formed through the rotating plate 213.

The guide 214 connects the flame nozzle 211a and a selected one of the holes of the rotating plate 213.

When the motor rotates, the rotating plate 213 is rotated. In accordance with the rotation of the rotating plate 213, the guide 214 moves reciprocally, so that the flame nozzle 211a pivots in one or more directions.

Thus, the torch 210a can automatically pivot when the V-shaped region, where the corners of the plates are positioned, is welded. Accordingly, it is possible to more conveniently perform the welding process. Therefore, it is possible to eliminate the trouble involved in conventional cases in which a cutting process is executed while manually swinging the torch.

### INDUSTRIAL APPLICABILITY

The cutting apparatus according to the present invention has remarkable effects in that it can prevent the body from moving during a cutting process due to an external pressure, and thus can achieve a precise cutting process, because the body is fixed to the rail provided with the fixing bar via the body fixing unit.

Also, there are remarkable effects in that the supply of gas to the torch is automatically cut off after the completion of the process, so that it is possible to prevent accidents caused by leakage of the gas.

In addition, the cutting apparatus according to the present invention has remarkable effects in that it can achieve various processes, for example, a process for cutting a plate-shaped workpiece, a process for cutting a workpiece into a shape conforming to the sample of a model, and a process for cutting an H-beam.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A cutting apparatus comprising:
a rail;
a body including a torch provided with a flame nozzle for generating flames in accordance with an ignition of a gas, a gas supplier for controlling whether or not the gas should be supplied to the torch, an arm carrying the torch at one end of the arm, and wheels seated on the rail, the wheels being movable in a direction intersecting an extension direction of the arm;
an arm driver including an arm driving motor to move the arm in the extension direction of the arm;
a wheel driver including a wheel driving motor to rotate the wheels;
a fixing bar protruded from the rail toward the body, the fixing bar extending in an extension direction of the rail and having a bent upper end; and
a body fixing unit including a fixing rod extending downwardly from a bottom of the body and having a bent lower end, and a roller mounted to the lower end of the fixing rod such that the roller is positioned beneath the bent upper end of the fixing bar, the fixing rod being movable toward the body to cause the roller to be pressed against the rail.

2. The cutting apparatus according to claim 1, wherein:
the arm includes an arm stopper protruded from the arm in a direction intersecting the extension direction of the arm; and
the rail includes a body stopper protruded from the rail toward the body seated on the rail;
the arm driver further includes a first sensor for sensing a contact state, in which the arm stopper comes into contact with the first sensor during a movement of the arm; and
the body further includes a second sensor for sensing a contact state, in which the body stopper comes into contact with the second sensor during a movement of the body along the rail, and a controller for stopping the arm driving motor when the first sensor senses the contact state of the arm stopper, and stopping the wheel driving motor when the second sensor senses the contact state of the body stopper.

3. The cutting apparatus according to claim 2, wherein:
the gas supplier includes a valve for controlling whether or not the gas should be supplied to the touch, and a valve cylinder for closing the valve; and
the controller controls the valve cylinder to close the valve when the controller stops the arm driving motor and the wheel driving motor in accordance with sensing operations of the first and second sensors.

4. The cutting apparatus according to claim 3, wherein the body fixing unit further includes:
a first cylinder for downwardly moving the fixing rod, thereby causing the fixing rod to release a pressing force of the roller applied to the fixing bar; and
an elastic member for upwardly moving the fixing rod when a force from the first cylinder causing the fixing rod to move downwardly is released, thereby causing the fixing rod to press the roller against the fixing bar.

5. The cutting apparatus according to claim 4, wherein the wheel driver further includes:
a first clutch unit, which receives a rotating force from the wheel driving motor, to rotate;
a second clutch unit for transmitting the rotating force from the wheel driving motor to the wheels; and
a second cylinder for urging the second clutch unit to engage with first clutch unit, thereby causing the second clutch unit to rotate.

6. The cutting apparatus according to claim 5, wherein:
the body further includes a first switch for activating the body fixing unit, and a second switch for activating the wheel driver; and
the controller controls the first cylinder of the body fixing unit to downwardly move the fixing rod when the first switch operates, and controls the second cylinder of the wheel driver to release an urging force applied to the second clutch unit when the second switch operates.

7. The cutting apparatus according to claim 6, further comprising:
a solenoid valve for supplying the gas to the valve cylinder, the first cylinder, and the second cylinder,
wherein:
each of the valve cylinder, the first cylinder, and the second cylinder comprises a pneumatic cylinder;
the gas supplier further includes a gas inlet tube for receiving the gas supplied to the gas supplier, a first gas outlet tube for discharging the gas received by the gas inlet tube to the torch, and a second gas outlet tube for discharging the gas received by the gas inlet tube to the solenoid valve;
the valve cylinder is arranged between the gas inlet tube and the first gas outlet tube; and
the controller controls the solenoid valve to control the supply of the gas to the valve cylinder, the first cylinder, and the second cylinder.

8. The cutting apparatus according to claim 1, wherein the arm includes:
a sample holder fixed to the arm at one end of the sample holder, the sample holder holding a sample at the other end of the sample holder;
a motor, which moves along an outer periphery of the sample while rotating, the motor having a lower end, to which the torch is mounted; and
a supporting unit including a first support carrying the motor at one end of the first support, a first hinge unit mounted to the other end of the first support, to pivot one end of the first support in accordance with the movement of the motor, a second support connected to the first hinge unit at one end of the second support, a third support fixedly mounted to the arm at one end of the third support, and a second hinge unit mounted to the other end of the third support, to hingeably move the first hinge unit about the other end of the third support in accordance with the movement of the motor.

9. The cutting apparatus according to claim 1, wherein the arm includes:
a motor;
a motor holder fixedly mounted to the arm at one end of the motor holder, the motor holder holding the motor the other end of the motor holder; and
a rotating member having one end rotating by the motor, and the other end bent in a direction intersecting a rotating axis of the motor, the rotating member holding the torch at the other end of the rotating member.

10. The cutting apparatus according to claim 1, wherein:
the extension direction of the arm corresponds to a protrusion direction of the fixing bar; and
the arm driver includes a first arm driver for moving the arm in the extension direction of the arm, the first arm driver including the arm driving motor, and a second arm driver for moving the first arm driver, to move the arm in a direction intersecting the extension direction of the arm.

11. The cutting apparatus according to claim 10, wherein:
the arm includes a groove extending in the extension direction of the arm; and
the first arm driver further includes a roller received in the groove, the roller rotating by the arm driving motor, to move the arm in the extension direction of the arm.

12. The cutting apparatus according to claim 11, wherein the second arm driver includes:
a pinion gear; and
a rack gear connected to the first arm driver at an upper surface of the rack gear, and engaged with the pinion gear at a lower surface of the rack gear, to move the first arm driver in a direction intersecting the extension direction of the arm in accordance with a rotation of the pinion gear.

13. The cutting apparatus according to claim 1, wherein:
the extension direction of the arm corresponds to a protrusion direction of the fixing bar; and
the rail includes a lower roller mounted to the rail and arranged beneath the rail, to move the rail in a direction intersecting the extension direction of the arm.

14. The cutting apparatus according to claim 1, wherein:
the torch has a ball shape at an end of the torch opposite to the flame nozzle; and
the arm includes a ball joint, in which the ball-shaped end of the torch is fitted, and a torch pivoting unit including a rotating plate formed with a plurality of diametrically-arranged holes, a guide having one end connected to one of the holes of the rotating plate, and the other end connected to the torch, and a motor for rotating the rotating plate, whereby the flame nozzle of the torch pivots in one or more directions in accordance with a rotation of the motor.
